(19) United States
(12) Patent Application Publication
(10) Pub. No.: US 2014/0310191 A1
(43) Pub. Date: Oct. 16, 2014

(54) Cyber-Bullying Response System and Method

(71) Applicant: Todd Schobel, Califon, NJ (US)

(72) Inventor: Todd Schobel, Califon, NJ (US)

(21) Appl. No.: 14/026,487

(22) Filed: Sep. 13, 2013

Related U.S. Application Data
(60) Provisional application No. 61/811,262, filed on Apr. 12, 2013.

(51) Int. Cl. G06Q 50/26; H04W 4/06

(52) U.S. Cl. CPC G06Q 50/265; H04W 4/06
USPC 705/325

(57) ABSTRACT

A method of rapid response to a cyber-bullying incident is provided by means of a “smartphone,” such as an iPhone™ or Android™, running anti-bullying application software. The application software, which is constantly running or available for launch on the smartphone of the minor user, enables the user to instantly initiate response and reporting of a cyber-bullying incident from a touchscreen menu. The application provides a user interface, which provides a menu of multiple alternate response and reporting actions and one or more input modules for associating a contact list with each of the menu actions. A version of the application for schools enables documentation of responsive actions to cyber-bullying incidents involving their students.

### RELATION TO OTHER APPLICATIONS

This application claims the benefit of the filing date of Provisional Patent Application No. 61/811,262 filed Apr. 12, 2013.

### BACKGROUND OF THE INVENTION

The present invention relates to the field of computer-implemented methods and computer systems for reporting and/or countering threats and/or abuse directed at minors. More particularly, the present invention relates to the field of application software which enables smart phones to be used for response to and reporting of incidents of “cyber-bullying.”

Advances in computer and telecommunications technology in recent decades has greatly exacerbated the effects of bullying on children, pre-teens and adolescents. Gone are the days when minors faced bullies only at school or at play, and could retreat into the shelter of their homes to escape them. The internet, e-mail, texting and social media now expose minors to threatening and abusive communications on a 24/7 basis. And the impact of such “cyber-bullying” is all too often tragically life-threatening—inducing severe depression and suicidal reactions in the victims.

Efforts by parents and school administrators to curtail cyber-bullying are frequently frustrated by the reluctance of the victims to report such incidents, whether due to feelings of helplessness or fear of retribution. What is needed is a system that empowers the victim to respond quickly and forcefully against the cyber-bully and simultaneously notify parents, school officials and police of the incident and the victim's response so as to deter retribution. Since studies have shown that victims of cyber-bullying are less likely to report or respond to an incident with the passage of time, an instant response/reporting capability is essential to the effectiveness of an anti-bullying system.

The present invention provides a method of rapid response to a cyber-bullying incident by means of a “smartphone,” such as an iPhone™ or Android™, running anti-bullying application software. The application software, which is constantly running or available for launch on the smartphone of the minor user, enables the user to instantly initiate response and reporting of a cyber-bullying incident from a touchscreen menu.

### SUMMARY OF THE INVENTION

At least one embodiment of the present invention describes a computer-implemented method for responding to and/or reporting one or more incidents of cyber-bullying using a smartphone. For purposes of this patent application, a smartphone is defined as a mobile telephone device which incorporates a hand-held computer with its own operating system, and which is capable of internet access, data storage, e-mail and SMS text communications. The smartphone operating system (OS) provides a standardized interface and platform for compatible application software.

The present invention provides a user interface, which provides a menu of multiple alternate response and reporting actions and one or more input modules for associating a contact list with each of the menu actions.

In at least one embodiment of the present invention, the menu includes a link to a “STOPit” software module, which, when activated from the smartphone touchscreen, sends a pre-composed “cease-and-desist” message to the cyber-bully in response to a specific cyber-bullying communication. Concurrently with sending the “cease-and-desist” response message to the bully, the “STOPit” module sends a copy of the offensive communication and the response to all of the contacts assigned to the “STOPit” function. Within a matter of seconds after receiving a cyber-bullying communication, therefore, the minor victim is able both to respond effectively and notify concerned adults so as to protect themselves from reprisals. This comprehensive instant response and notification capability is the key to the effectiveness of the present invention and sets it apart from the prior art.

In one example, the cyber-bullying communication is in the form of a SMS text message to the victim/user. In response to a prompt, the user indicates that the cyber-bullying communication is a text message, whereupon the STOPit module provides a drop-down list of the most recent SMS messages received. After the user selects the offending message from the drop-down list and activates a “send” button, the STOPit module causes the smartphone to send the canned “cease-and-desist” message to the cyber-bully and also sends copies of the text messages exchanged between the bully and the victim/user to the contact list assigned to the STOPit module.

In another example, the cyber-bullying communications is something other than an SMS text message, such as an e-mail or a posting on a social media website. Upon the user's indication that the cyber-bullying communication is something other than SMS text, the STOPit module prompts the user to take a screen shot of the offensive content. When the “send” button is activated, the STOPit module causes the smartphone to send the canned “cease-and-desist” message to the cyber-bully. Simultaneously, the STOPit module causes the smartphone to send the screen shot of the offensive content to the user's STOPit contact list.

In at least one embodiment of the present invention, the menu provided by the user interface also includes a link to a “REPORTit” software module. When activated from the smartphone touchscreen, the REPORTit module prompts the user to take a screen shot of offensive content or select a screen shot already stored on the phone. The user is also prompted to optionally associate an explanatory comment with the selected screen shot and to designate recipients of the report, which may be from the user's STOPit contact list or may be added by entering a new e-mail address. The REPORTit function permits the user to report threatening communications, such as those of cyber-predators, regardless of whether the user has been personally involved.

In at least one embodiment of the present invention, the menu provided by the user interface also includes a link to a “FRIENDit” software module. The FRIENDit module replicates the functionality of the REPORTit module, except that the report of threatening communications is sent from an e-mail address that does not disclose the user's identity, so that the user's anonymity is preserved.

In at least one embodiment of the present invention, the menu provided by the user interface also includes a link to a “HELPit” software module. The HELPit module can be activated from the touchscreen menu or optionally it can be activated automatically upon the user's completion of a STOPit action. When activated, the HELPit module causes the smartphone to display the HELPit contact, which consists of various hotlines and/or support networks for minors facing stressful situations. Some of the HELPit contacts can be pre-populated in the software, while others can be added by the minor users and/or their parents/guardians and/or school officials.

In all embodiments of the present invention, the user interface includes a Setup module, which controls the inputting and/or importation of contacts for each of the functional software modules, such as STOPit, REPORTit, FRIENDit and HELPit. Optionally, the Setup module can allow parents/guardians and/or school officials to pre-populate the contact lists with certain contacts that cannot be deleted or altered by the minor user.

The foregoing summarizes the general design features of the present invention. In the following sections, specific embodiments of the present invention will be described in some detail. These specific embodiments are intended to demonstrate the feasibility of implementing the present invention in accordance with the general design features discussed above. Therefore, the detailed descriptions of these embodiments are offered for illustrative and exemplary purposes only, and they are not intended to limit the scope either of the foregoing summary description or of the claims which follow.

### BRIEF DESCRIPTION OF THE DRAWINGS

FIGS. 1A-1D comprise a series of exemplary wireframes depicting initial setup of the application software of the preferred embodiment of the present invention;

FIGS. 2A-2E comprise a series of exemplary wire frames depicting how the application software of the preferred embodiment of the present invention is launched;

FIGS. 3A-3D comprise a series of exemplary wireframes depicting how the application software of the preferred embodiment of the present invention inputs and assigns contacts to each of its functional modules;

FIGS. 4A-4H comprise a series of exemplary wireframes depicting the operation of the STOPit module;

FIGS. 5A-5I comprise a series of exemplary wireframes depicting the operation of the FRIENDit module;

FIGS. 6A-6B are exemplary wire frames depicting the operation of the HELPit module;

FIGS. 7A-7I comprise a series of exemplary wireframes depicting the operation of the REPORTit module;

FIGS. 8A and 8B are exemplary wireframes depicting the operation of the Setup/Help function; and

FIGS. 9 and 10 are exemplary screens depicting the operation of the DOCUMENTit module in the school version of the application software of the preferred embodiment of the present invention.

### DETAILED DESCRIPTION OF THE PREFERRED EMBODIMENT

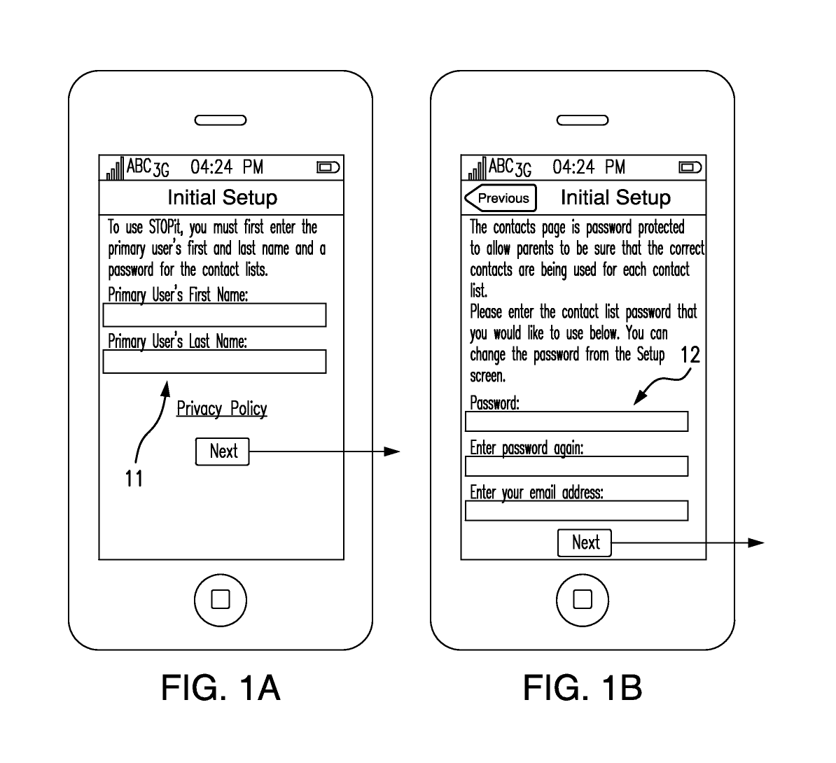

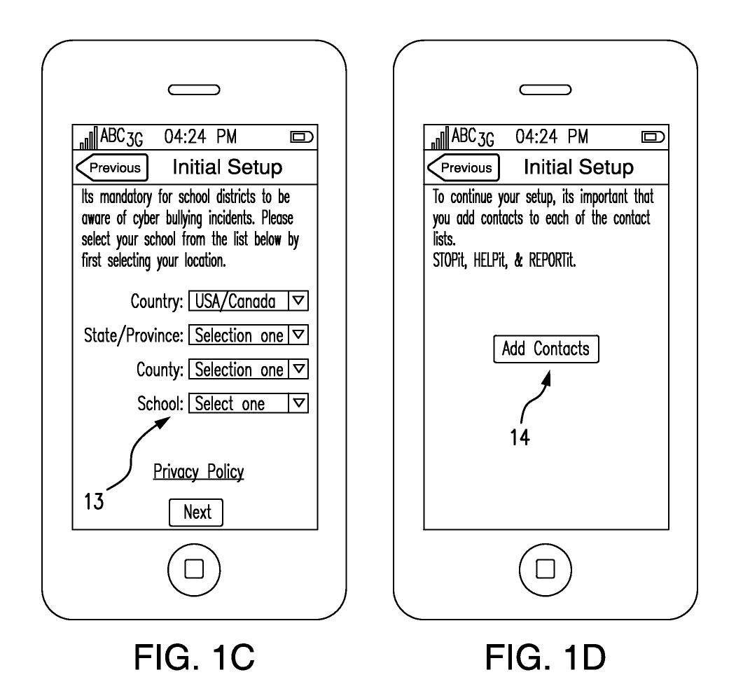

Referring to FIGS. 1A-1D, the Initial Setup screens require the input of user name 11, password 12 and school identification 13. Then the user is prompted 14 to add contacts to contact lists for each of the application modules. A check is performed with the server to determine if the identified school has designated a School Cyberbully Contact, and if it has, that contact is added to all of the contact lists.

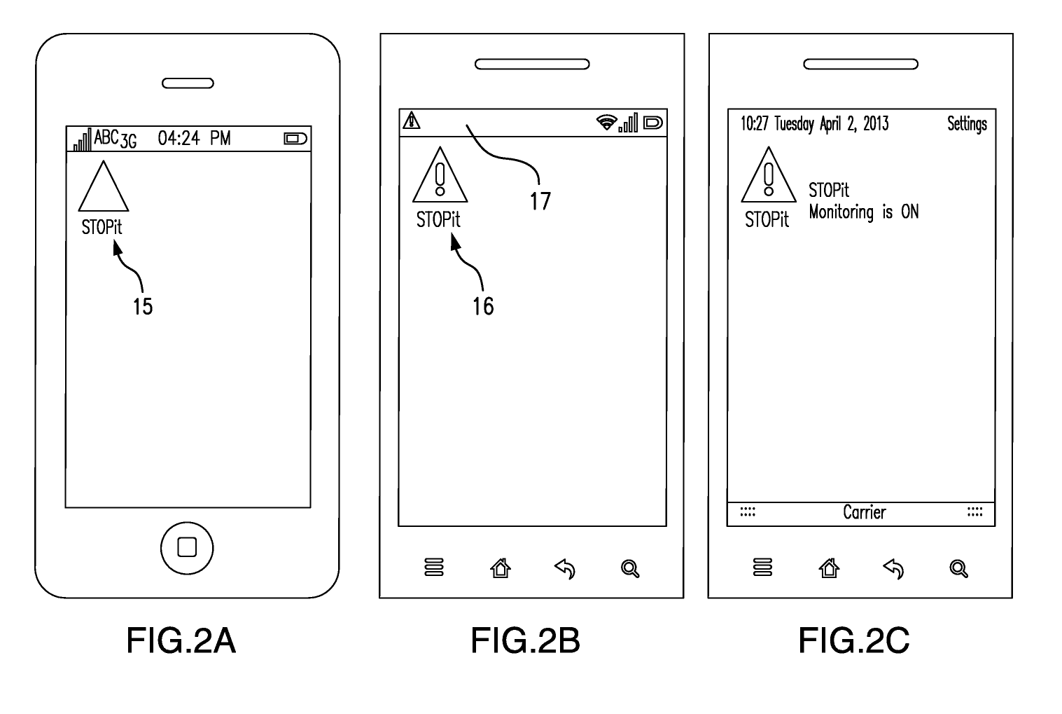

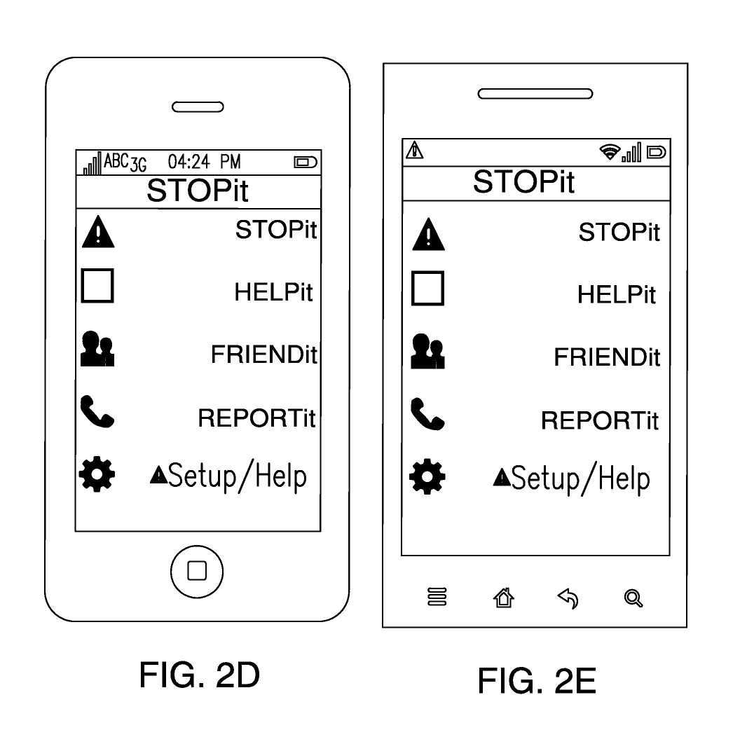

Referring to FIGS. 2A-2E, the launching of the application is depicted on an exemplary iPhone™ (round-cornered frame) and Android™ (square-cornered frame). In the former, the application is a standard application 15 that needs to be launched (as shown in FIG. 2A), while in the latter it is both a standard application 16 as well as a running application in the notification area 17 (as shown in FIGS. 2B and 2C, respectively). Upon startup, the application will contact the server to check the status of the School Cyberbully Contact and will enable/disable the contact based on that status. As shown in FIGS. 2D and 2E, the home screen for the application is the same for both iPhone™ and Android™ devices, regardless of how the application is launched.

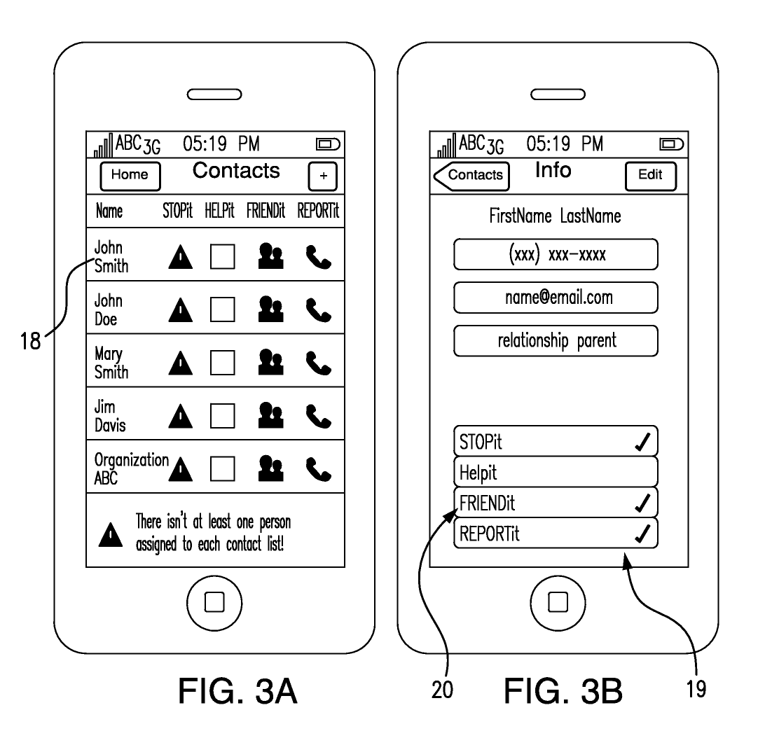

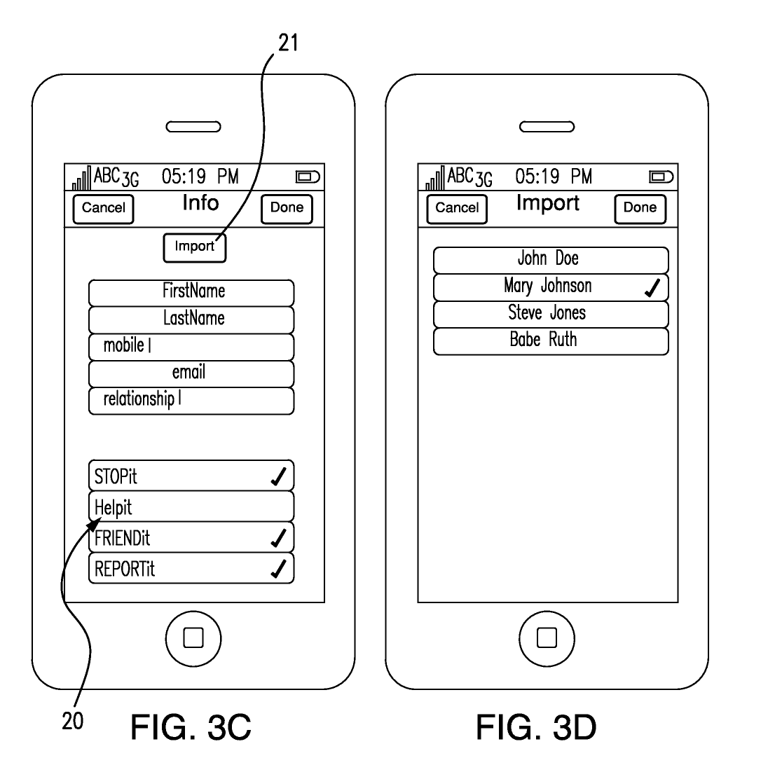

FIGS. 3A-3D depict exemplary screens used for populating the contact lists for each of the application's functional modules. Clicking on a contact's name 18 will take the user to an information page 19 for that contact. On the information page 19 appear entries for the functional modules 20, which are here listed as STOPit, HELPit, FRIENDit and REPORTit. Module entries 20 when clicked will show a check mark, indicating that the contact has been added to the contact list for that module. Clicking again on the module entry 20 will remove the checkmark and delete the contact from that module's list.

As shown in FIGS. 3C and 3D, clicking on an “Import” button 21 will allow the user to access the contacts stored on their smartphone and import those contacts into the contact lists of one or more of the application modules, again using the module entries 20.

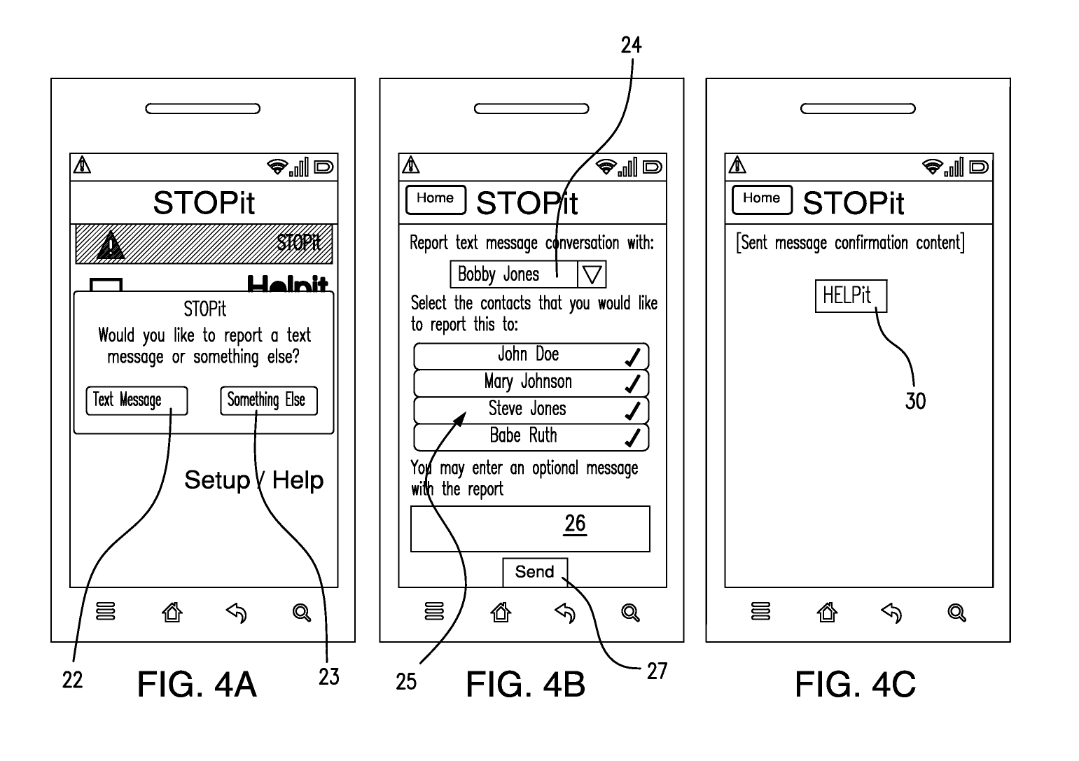

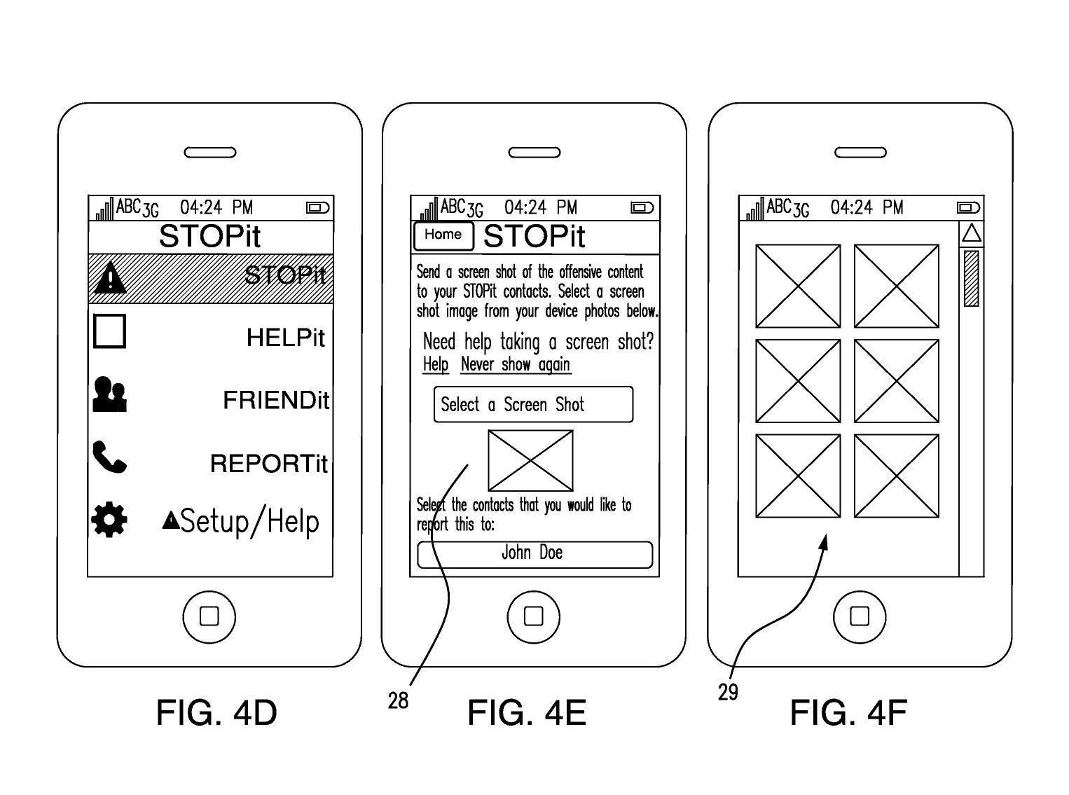

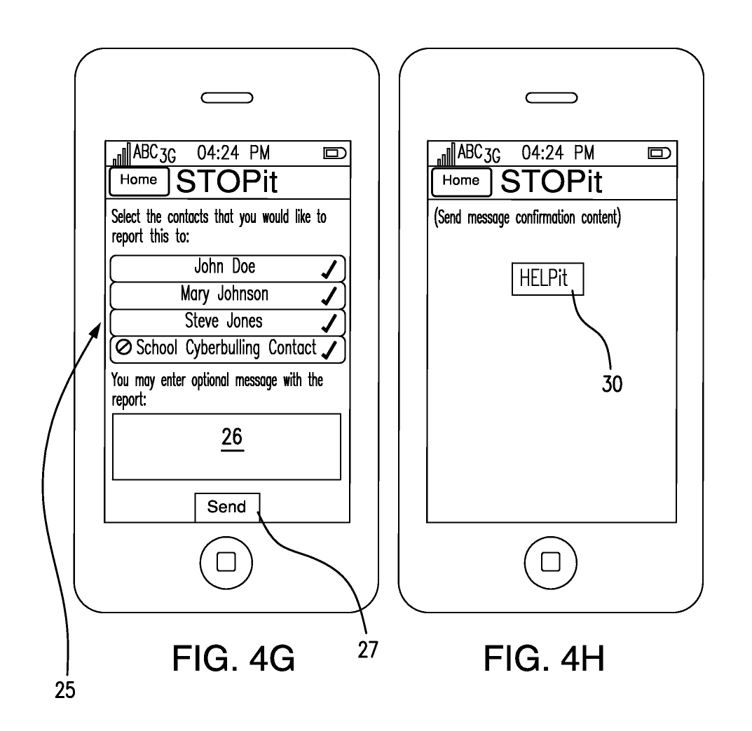

FIGS. 4A-4H illustrate the use of the STOPit module with iPhone™ (round-cornered frame) and Android™ (square-cornered frame) type smartphones. In Android™ type devices (FIGS. 4A-4C), the STOPit module first prompts the user to indicate whether the cyber-bullying communication is a text message 22 or something else 23.

Clicking on “text message” 22 will bring the user to the screen shown in FIG. 4B, which has a dropdown list 24 of the phone numbers from which the user's phone has received SMS text messages, in chronological order with the most recent at the top. If the sender's phone number appears on one of the application's contact lists, the dropdown list 24 will show the sender's name. On the same screen, the user can designate contacts from the STOPit contact list 25 to receive the report of this incident, and can add an optional message 26. Clicking the send button 27 at the bottom of this screen causes the STOPit module to have the smartphone send a pre-composed “cease-and-desist” response message to the sender of the cyber-bullying text. The STOPit module concurrently will also send via text and e-mail to all designated contacts copies of the user's response message and the recent text messages exchanged between the user and the cyber-bully.

If the user has an iPhone™ type device, or if the user of an Android™ type device is responding to a cyber-bullying communication that is something other than a text message, the exemplary STOPit response process proceeds through the screens depicted in FIGS. 4D-4G. The STOPit module prompts the user to take one or more screen shots of the offensive material 28, which may be an e-mail or a posting on a social media website. Screenshots 29 are then selected for inclusion in the incident report and contacts are designated from the STOPit list to receive the report 25. An optional message 26 to go with the report can also be added by the user. When the user clicks the send button 27, the canned “cease-and-desist” text message is sent by the phone to the cyber-bully. Concurrently, the STOPit module causes the smartphone to send a copy of the “cease-and-desist” message and the screen shot(s) of the offensive material to the user's STOPit contact list.

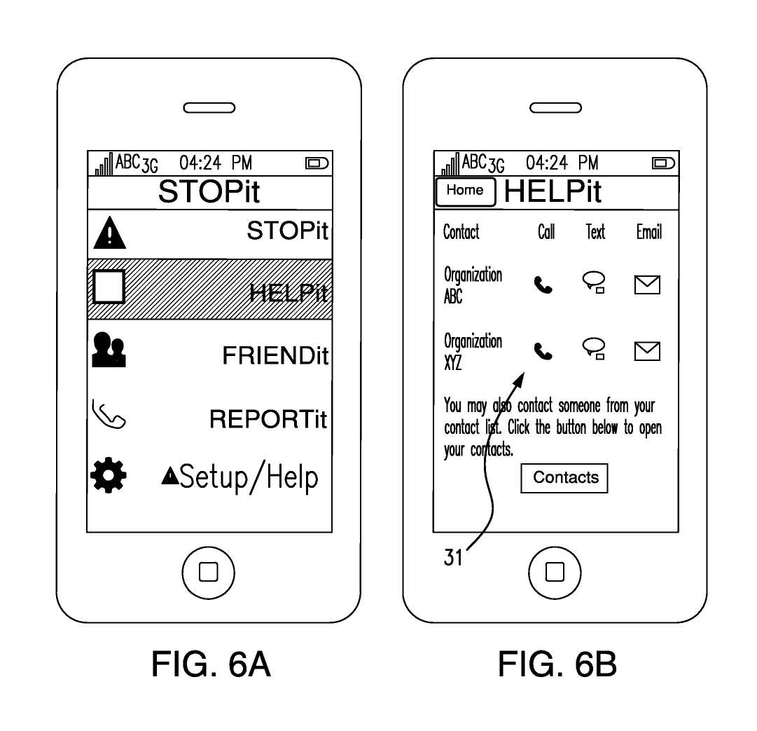

As shown in FIGS. 4C and 4H, when the STOPit response/reporting process is completed, the user is taken to a screen with a HELPit button 30, which when clicked activates the application's HELPit module. As depicted in FIGS. 6A and 6B, the HELPit module enables the user to seek aid or counselling from designated contacts comprising hotlines or networks for victims of cyber-bullying 31.

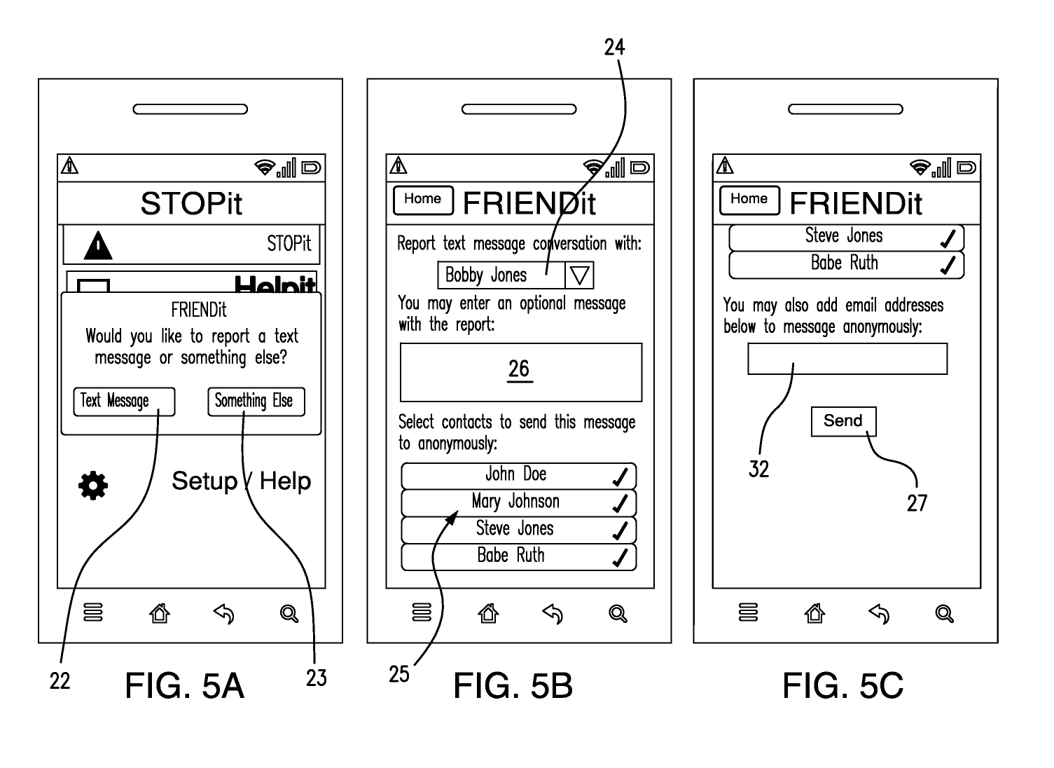

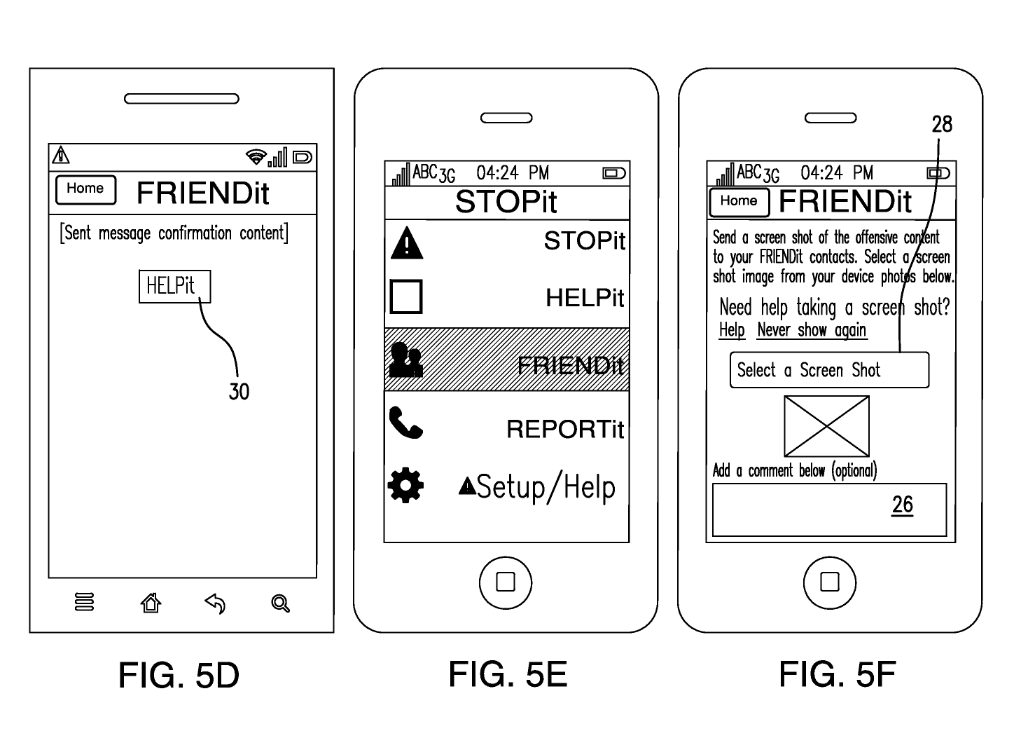

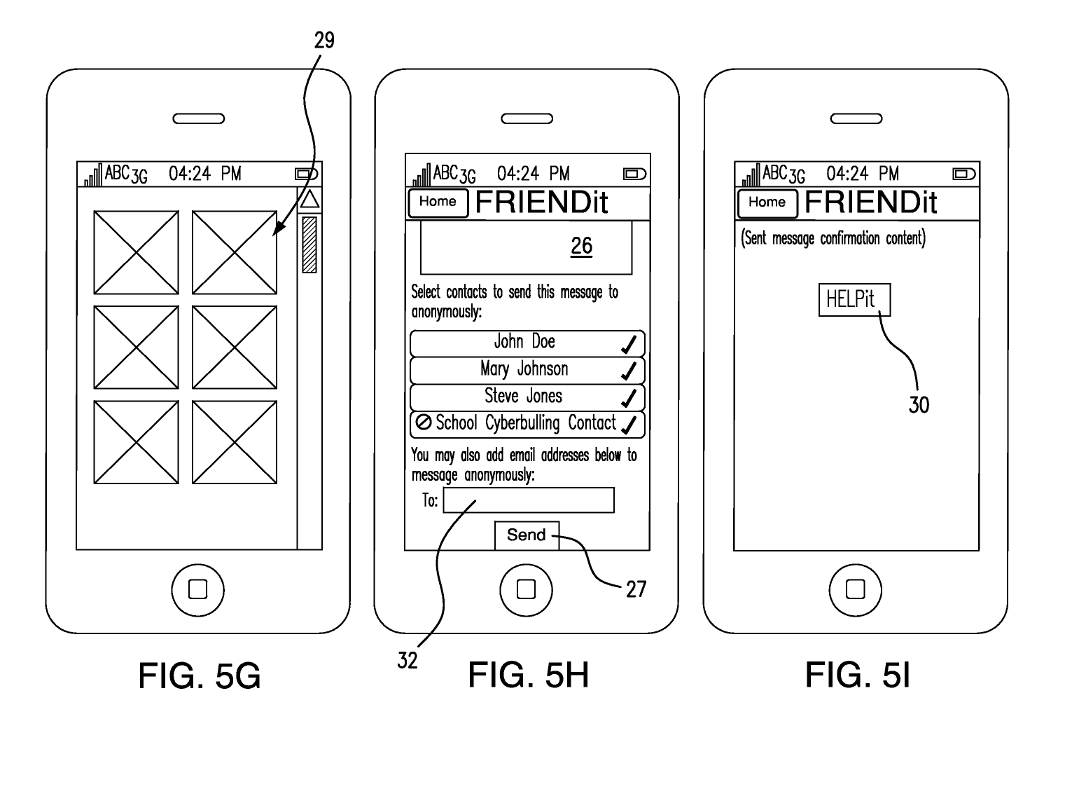

FIGS. 5A-5I illustrate the operations of the application's FRIENDit module. In this case the user is anonymously reporting a cyber-bullying incident directed not at themselves but at another victim. The FRIENDit screens follow the same processes that are described above for the STOPit module, except that the “send” screen (FIG. 5H) allows the entry of e-mail addresses 32 as recipients of the report in addition to the FRIENDit contact list. Another difference is that the FRIENDit report does not include a response message to the cyber-bully, and the report is sent anonymously through the application server, rather than from the user's e-mail/text account.

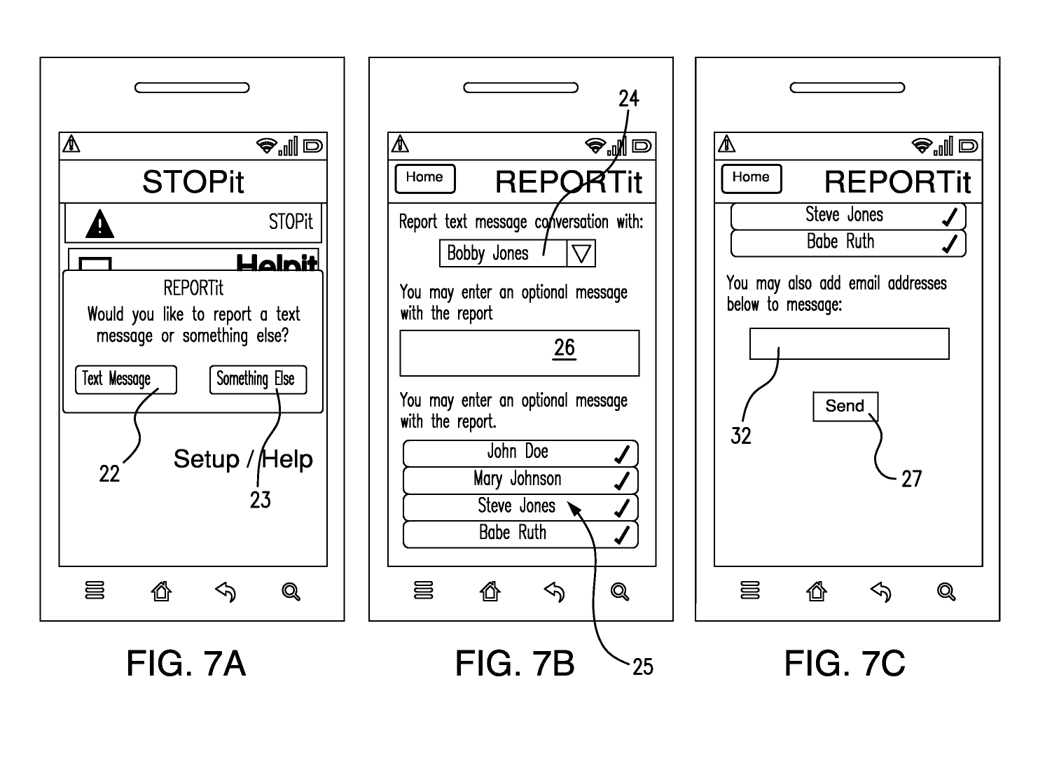

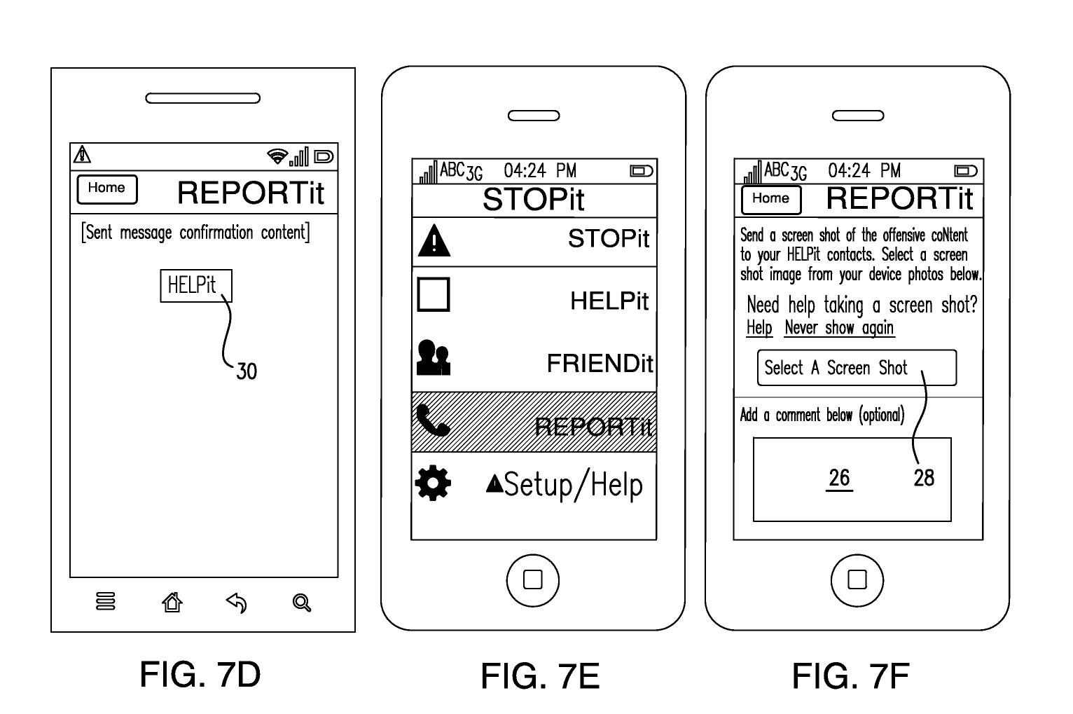

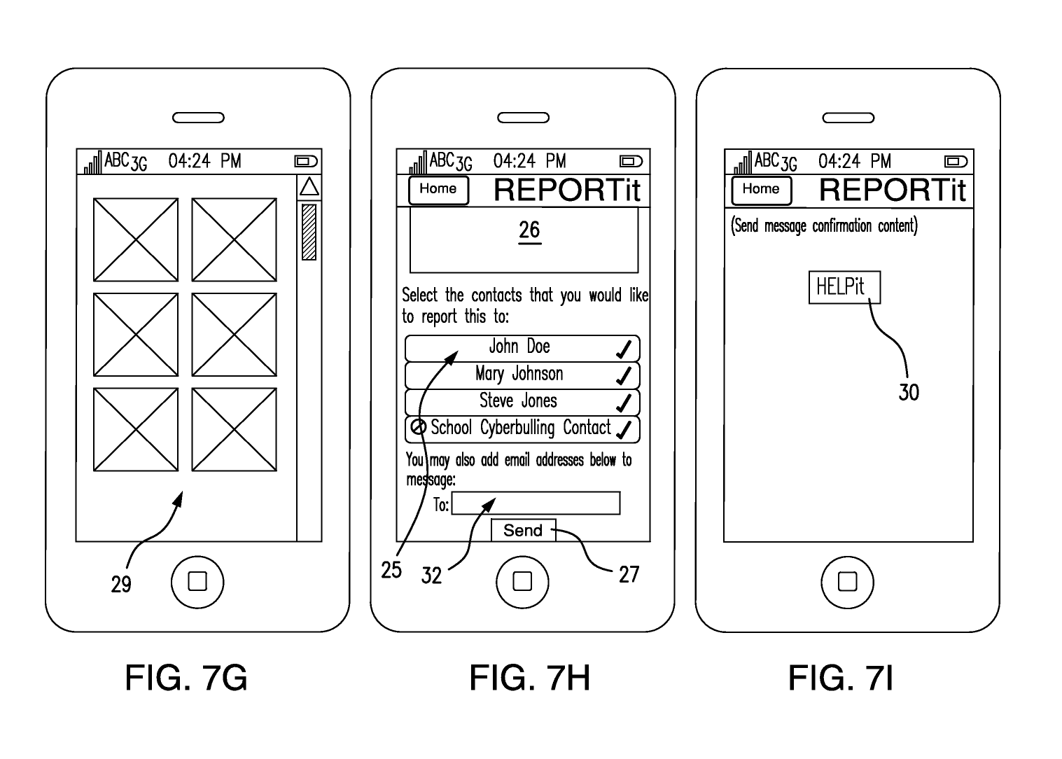

As depicted in FIGS. 7A-71, the REPORTit module follows the same process as the FRIENDit module, except that the report is not made anonymously. In this case, as in the FRIENDit module, the user is reporting cyber-bullying or predatory communications pertaining not to themselves but to another victim.

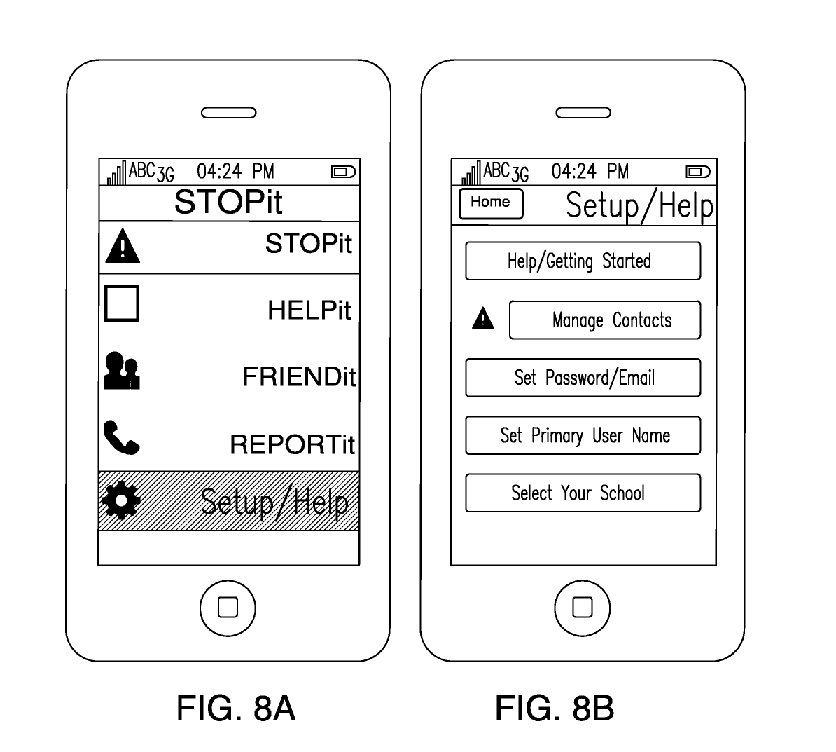

FIGS. 8A and 8B show exemplary screens associated with the application's Setup/Help functions, through which the user can update his/her contact lists and school information.

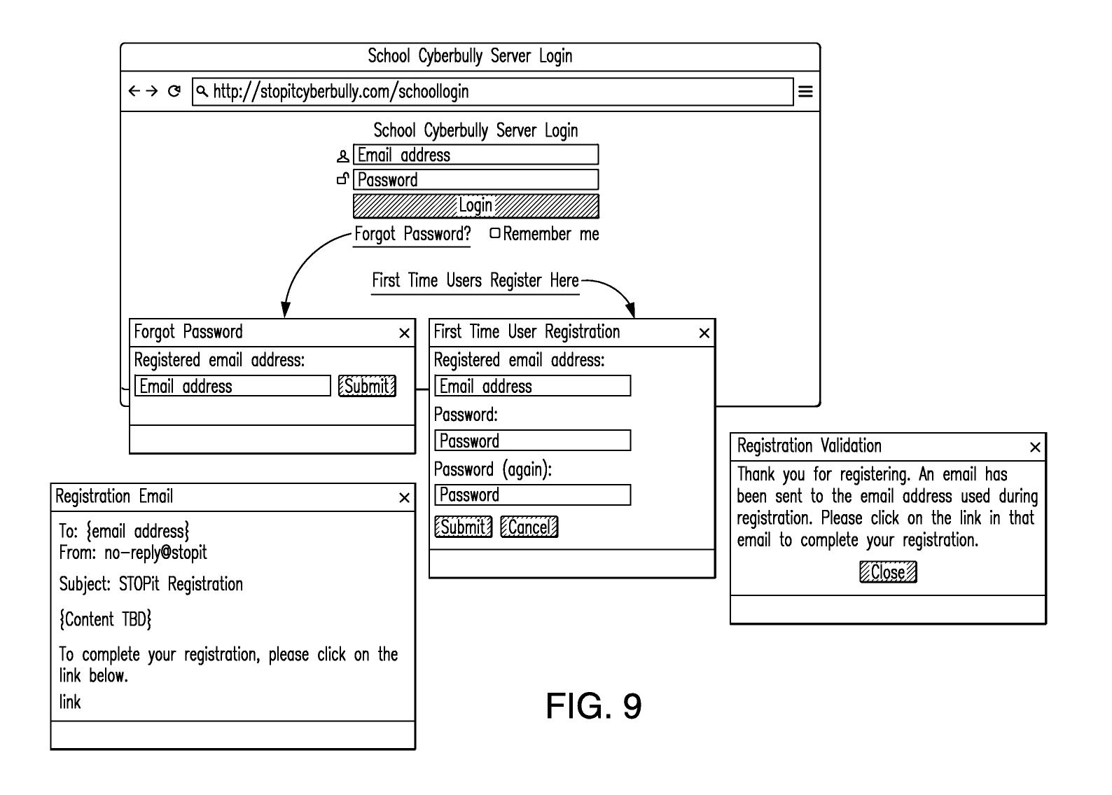

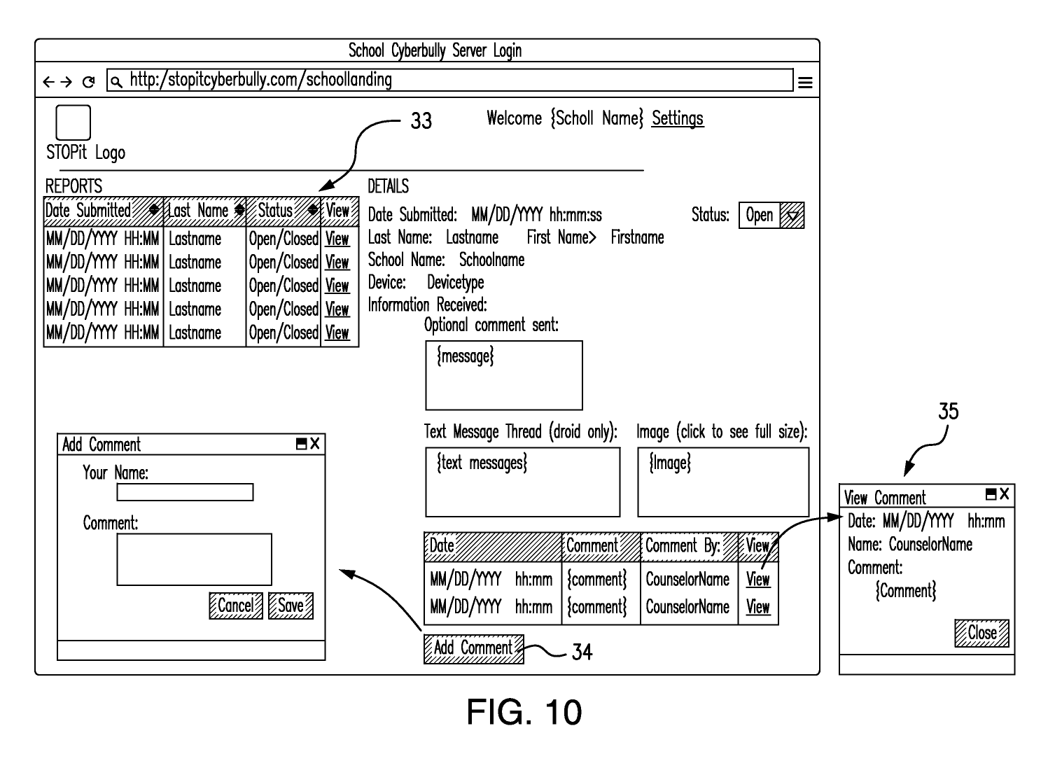

Referring to FIGS. 9 and 10, the version of the application provided to schools includes a DOCUMENTit module. This module allow the school's Cyberbully Contact and/or administrators to access, through the server's website, incident reports received from students 33 and to add comments/updates to the report 34, which are date-time stamped and become part of the school's record 35 of the incident. The DOCUMENTit module thereby enables the school to document its response to cyber-bullying incidents.

Although the preferred embodiment of the present invention has been disclosed for illustrative purposes, those skilled in the art will appreciate that many additions, modifications and substitutions are possible, without departing from the scope and spirit of the present invention.

The invention claimed is:

1. A method for using a smartphone of a user to respond to one or more cyber-bullying incidents, the method comprising:
providing the smartphone with a user interface, comprising a setup module, one or more input modules, a menu, and multiple action modules;
using the setup module to establish a user name and a password, and to obtain parental/guardian consent if the user is a minor;
using the input module(s) to associate a contact list, comprising one or more primary contacts, with each of the action modules;
using the menu to select an incident response action corresponding to one of the action modules;
initiating the incident response action through the user's smartphone, as directed by the selected action module; and
sending contact notification(s) of the cyber-bullying incident and the incident response action via text or e-mail through the user's smartphone to each of the primary contacts on the contact list associated with the selected action module.

2. The method of claim 1, wherein the cyber-bullying incident(s) comprise one or more offensive communication(s) sent via text or e-mail by a cyber-bully to the user or disseminated by the cyber-bully on the internet, and wherein one of the action modules is a first action module, and wherein the first action module, when selected, initiates a first incident response action consisting of sending, through the user's smartphone, a pre-composed cease-and-desist text or e-mail message to the cyber-bully.

3. The method of claim 2, wherein one of the action modules is a second action module, and wherein the second action module, when selected, initiates a second incident response action, consisting of anonymously sending, through the user's smartphone via an internet server, copies of the offensive communication(s) with an explanatory message, to each of the primary contacts on the contact list associated with the second action module, as well as to one or more designated secondary contacts.

4. The method of claim 3, wherein one of the action modules is a third action module, and wherein the third action module, when selected, initiates a third incident response action, consisting of sending, through the user's smartphone, copies of the offensive communication(s) with an explanatory message, to each of the primary contacts on the contact list associated with the third action module, as well as to one or more designated secondary contacts.

5. The method of claim 4, wherein one of the action modules is a fourth action module, and wherein the fourth action module, when selected, initiates a fourth incident response action, consisting of contacting, through the user's smartphone, one or more hotlines or support networks for victims of cyber-bullying.

6. The method of claim 5, comprising the additional steps of using the setup module to identify the user's school or workplace and configuring the input module(s) to add as primary contacts one or more priority contacts from the user's school or workplace to the contact lists associated with the first, second and third action modules.

7. The method of claim 6, comprising the additional step of providing a website which is password accessible to the priority contacts and on which time-and-date stamped contact notifications and incident response actions are compiled in an incident file for each cyber-bullying incident.

8. The method of claim 7, comprising the additional step of enabling the priority contacts to supplement the incident file with time-and-date stamped notations of actions taken by the user's school or workplace to address the cyber-bullying incident.
